(19) United States
(12) Patent Application Publication
(10) Pub. No.: US 2005/0212298 A1
(43) Pub. Date: Sep. 29, 2005

(54) System for electric generating using accumulation pressure

(76) Inventor: Ming-Shyuan Yeh, Taipei Hsien (TW)

Correspondence Address: BACON & THOMAS, PLLC, 625 SLATERS LANE, FOURTH FLOOR, ALEXANDRIA, VA, 22314, US

(21) Appl. No.: 10/806,168

(22) Filed: Mar. 23, 2004

(51) Int. Cl. H02P 9/04

(52) U.S. Cl. 290/1 A

(57) ABSTRACT

The electric generating system comprises: a pressure-accumulating unit, an energy-converting unit and a pressure compensation unit; wherein fluid stored in the pressure-accumulating unit is released continuously with a high speed to form a spraying flow to drive the energy-converting unit to thereby further convert kinetic energy into electric energy; and the pressure compensation unit pressurizes the fluid and injects it into the pressure-accumulating unit to continuously supply required fluid and maintain a stable working pressure, this can afford the electric power requirement for outputting of a posterior delivery and distributing equipment.

### BACKGROUND OF THE INVENTION

1. Field of the Invention

The present invention is related to a technique to convert energy to achieve an object of sustaining electric generating, and especially to provide an auxiliary electric power supplying system without energy burning or public pollution.

2. Description of the Prior Art

Looking around the tendency of requirement and supplying of energy of the world, the situation of energy sources and the environment of management of domestic as well as foreign energy sources have been changed; in order to follow the market development of the global energy sources as well as the impact of the problem of pollution induced by using energy sources; governments pay much efforts to promote development and application of separated and clean electric generating with an object of hoping to build electric generating systems at the users' terminals all over their countries, this is different from the large scaled and concentrated modes of electric generating by thermal power or nuclear energy. They aim at overcoming insufficiency of large scaled electric power development with the popularized small and separated electric power systems, and solving the problem of protests and resistances on environmental protection by elevating the efficiency of as well as cleaning of energy sources; also they aim at reducing loss of electric power transmission and providing electric power of high quality and high reliability. According to the general custom of household electricity application, electricity consumption of a small family is under but about 10 kilowatts, hence development of small electric generators is suitable; as to district electricity consumptions of multi-storied buildings for offices, hospitals and communities etc., multiple small electric generating modules can be combined to supply electric power to reduce reliance on large scaled electric power plants, and thereby the object of reducing loss of electric power transmission and providing electric power of high quality and high reliability can be attained.

However, spare electric generators (or small electric generators) seen in multi-storied buildings mostly use combustible oil as the energy source for running of engines, and the engines actuate the electric generators; this not only consumes more cost for electric generating, but also can derive pollutions of air, noise etc., and long-time running in high temperatures of the engines may result mechanical wear, the engines can only be used as urgent spare power sources for temporary operation, and are unable used as electric generating equipment for long-time sustaining operation.

### SUMMARY OF THE INVENTION

The entire system for electric generating using accumulation pressure of the present invention basically comprises: a pressure-accumulating unit, an energy-converting unit and a pressure compensation unit; wherein the pressure-accumulating unit stores fluid with adequate pressure and amount, the fluid is released continuously with a high speed in operation; the energy-converting unit runs under the high speed fluid spraying action released from the pressure-accumulating unit to thereby convert kinetic energy into electric energy; while the pressure compensation unit pressurizes the fluid and injects it into the pressure-accumulating unit to continuously supply required fluid and maintain a stable working pressure, this is beneficial to use for outputting of a posterior delivery and distributing equipment.

When in actual operation of the electric generating system of the present invention, the pressure-accumulating unit continuously releases a quantity of liquid fluid (such as the liquid water, oil etc.) in a high speed by means of compressed gas, the liquid fluid released in the high speed forms a spraying flow to rotate a turbine of the energy-converting unit, the turbine thereby creates a better rotating effect.

And before normal electric generating of the entire electric generating system, pre-stored electric power of an electric cell is used (or by way of direct pressurizing of a high-pressure gas bottle) to make the pressure-accumulating unit get a working pressure sufficient for driving the energy-converting unit to run; and after power generating of the electric generating system, a part of the electric power is switched to afford running a pressurizing pump of the pressure compensation unit, the fluid recovered by the pressurizing pump is pressurized and injected into a pressure-accumulating cylinder of the pressure-accumulating unit; and during supplying fluid in a recycling mode, the pressure-accumulating cylinder will compress the internal gas to reduce its volume by injection of the fluid, thus the pressure-accumulating cylinder can get an effect of pressure compensation; so that after normal electric generating of the electric generating system, supplying of electric power of the electric cell is stopped.

Especially, when in electric generating of the entire electric generating system, the pre-stored electric power is converted into compressive kinetic energy for rotating the turbine; or a kind of pre-stored compressive kinetic energy (from the high-pressure gas bottle) is formed for rotating the turbine, then the turbine actuates the electric generator to further convert the kinetic energy into electric power, and a part of the electric power is converted into compressive kinetic energy to maintain running of the entire electric generating system; after suitable amount of energy consumption, an object of sustaining electric generating by the mode of converting of energy can be realized. This not only can use the electric power generated as auxiliary electric power, but also no problem of public pollution will be induced during the process of operation of the electric generating system by the fact that there is no burning of any energy source.

The present invention will be apparent in its structure combination after reading the detailed description of the preferred embodiment thereof in reference to the accompanying drawings.

### BRIEF DESCRIPTION OF THE DRAWINGS

FIG. 1 is a perspective view structurally showing the appearance of a preferred embodiment of electric generating system of the present invention;

FIG. 2 is a perspective view structurally showing the appearance of a turbine of the present invention;

FIG. 3 is a plane view showing the structure of the electric generating system of the present invention;

FIG. 4 is a sectional view showing the structure of a pressure-accumulating unit, the turbine and a storage tank of the present invention;

FIG. 5 is a sectional view showing the structure of the storage tank of the present invention.

### DETAILED DESCRIPTION OF THE PREFERRED EMBODIMENT

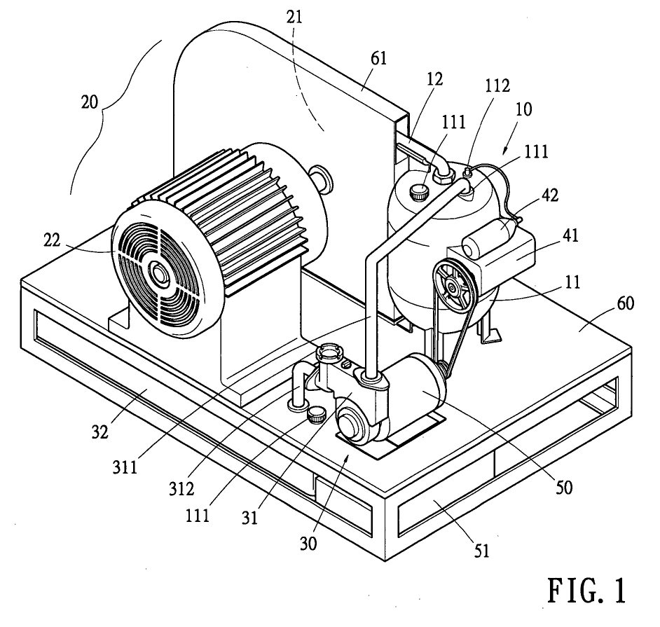

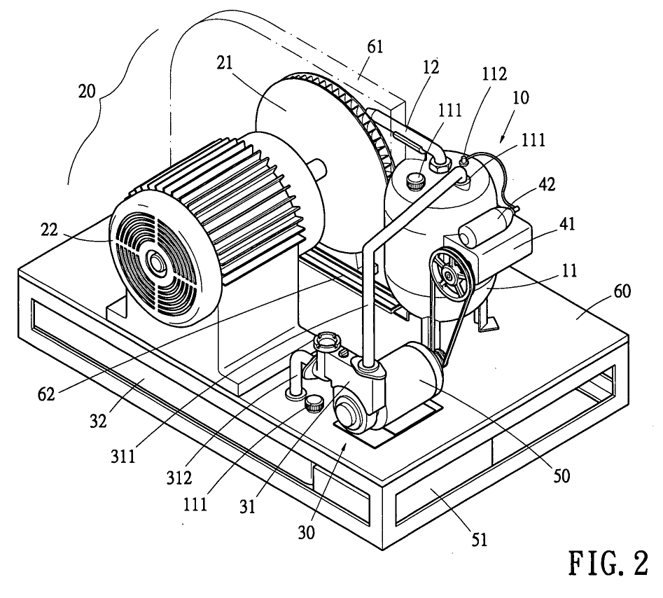

Referring to FIGS. 1 and 2 showing the structural combination of the system for electric generating using accumulation pressure of the present invention, the entire electric generating system basically is composed of a pressure-accumulating unit 10, an energy-converting unit 20 and a pressure compensation unit 30; and a base 60 is provided to function as a base body for mounting the abovementioned units and their related components. Wherein:

The pressure-accumulating unit 10 is used to store fluid with adequate pressure and amount; the fluid is released continuously with a high speed in operation. In the present embodiment, the pressure-accumulating unit 10 is provided with a pressure-accumulating cylinder 11 to store liquid fluid (such as liquid water, oil etc.) and to compress gas, the pressure-accumulating cylinder 11 is provided with fluid injection holes 111 for fluid complementing and inputting in a recycling mode, and with a gas injection hole 112 connecting with a high-pressure gas bottle 42 and an air compressor 41, the high-pressure gas bottle 42 and the air compressor 41 inject air into the pressure-accumulating cylinder 11 to make the latter get the state of having adequate pressure.

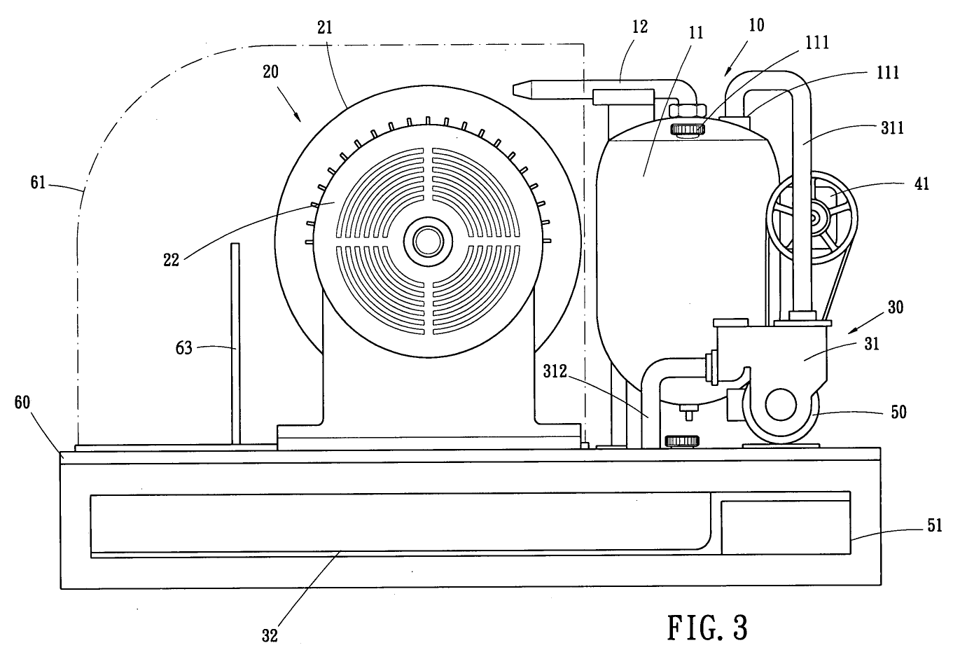

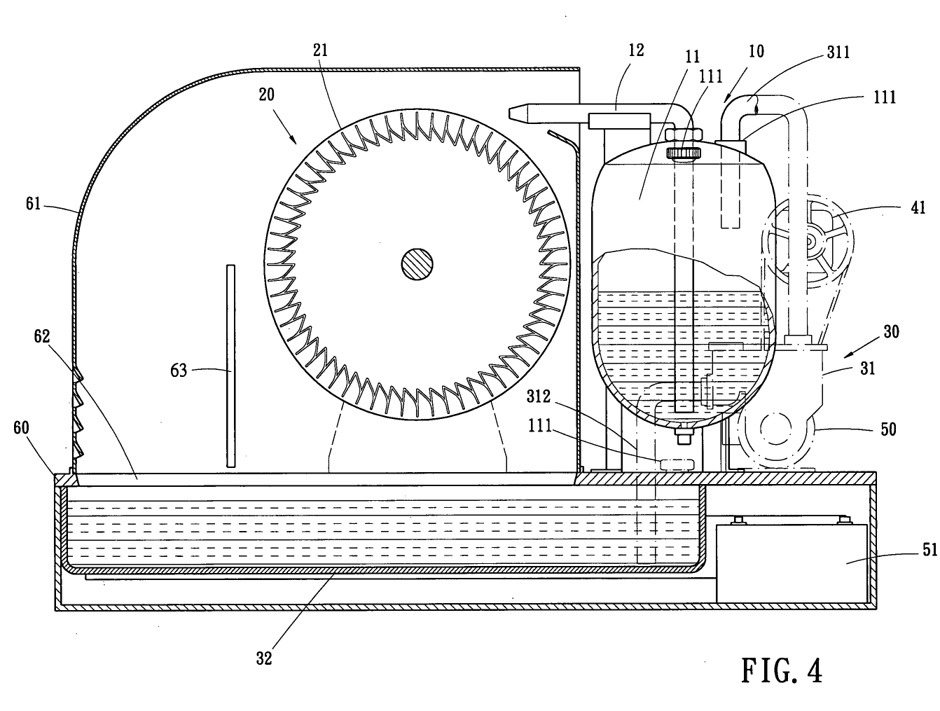

Referring simultaneously to FIGS. 3 and 4, the pressure-accumulating cylinder 11 is provided on the top thereof with a fluid spraying pipe 12, one end of the fluid spraying pipe 12 is extended into a position under the surface of the liquid fluid in the pressure-accumulating cylinder 11, so that by the pressure of the compressed air, the liquid fluid is continuously released from the fluid spraying pipe 12 with a high speed to form a high speed spraying flow to effect operation of the energy-converting unit 20.

The energy-converting unit 20 is provided with a turbine 21 driven by the high speed spraying flow, and with an electric generator 22 driven by the turbine 21; by operation of the turbine 21 and the electric generator 22, kinetic energy can be converted into electric energy. Certainly, the turbine 21 and the electric generator 22 can be driven by a gear shifting mechanism (not shown); the gear shifting mechanism has its formed ratio of rotation speed adjusted in pursuance of the operating power of the electric generator 22, in order that the electric generator 22 can maintain the state of operation with stable electric power supplying.

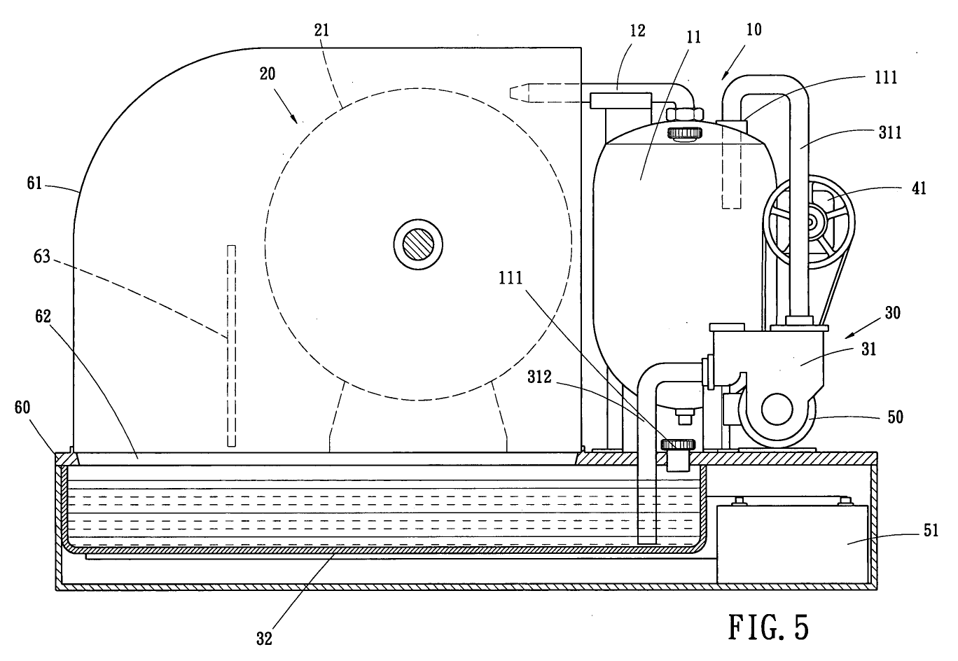

Moreover, the pressure compensation unit 30 mainly is to pressurize the fluid and inject it into the pressure-accumulating unit 10 to continuously supply required fluid and maintain a stable working pressure. In the present embodiment, the pressure compensation unit 30 is provided with a pressurizing pump 31; and the pressurizing pump 31 is provided with a water injecting pipe 311 connecting to a fluid injection hole 111 of the pressure-accumulating cylinder 11 being beneficial to supplying fluid and pressure compensation, and further is provided with a storage tank 32 to collect the discharged fluid from the energy-converting unit 20. As shown in FIGS. 2 and 5, the base 60 is provided with an obscuring member 61 to impede the sputtering fluid from the turbine 21, and is provided with a penetrated area 62 at a position in opposition to the turbine 21; the obscuring member 61 is allocated in contiguity to the penetrated area 62; and the storage tank 32 is allocated under the penetrated area 62 of the base 60, so that the discharged fluid from the energy-converting unit 20 can be effectively collected. The pressurizing pump 31 is cooperatively provided with a water-extracting pipe 312 extended into the interior of the storage tank 32, the pressurizing pump 31 pressurizes and injects the collected fluid into the pressure-accumulating cylinder 10 to get an effect of continuously operating in a recycling mode, and the released liquid fluid can be recovered for reusing.

One thing worth mentioning, during the practical operation of testing of the electric generating system of the present invention, there has been a phenomenon of interference with the turbine 21 by fluid rebounded from the obscuring member 61. Thereby, a stop plate 63 can be provided at a partial section between the obscuring member 61 and the turbine 21 to avoid the probable interference with the turbine 21; certainly, when in operation of the entire electric generating system, the fluid injection hole 111 allocated in the storage tank 32 can be injected with fluid of adequate amount in advance, so that the interior of the storage tank 32 can maintain the amount of fluid adequate to afford fluid extracting of the pressurizing pump 31, thereby an independent circulative operating system is formed.

And more, in the present embodiment, the pressurizing pump 31 of the pressure compensation unit 30 and the air compressor 41 can be driven by a single electrical motor 50; and an electric cell 51 can be provided in the base 60, the electric cell 51 prestores electric power required for operating the electrical motor 50, so that after the entire electric generating system is normally supplied with electric power, the electric power can be switched for use of the electric cell 51 (in supporting operation of the air compressor 41 and the pressurizing pump 31).

Therefore, during operation of the entire electric generating system, the pressure-accumulating cylinder 10 continuously releases stored liquid fluid in a high speed to form a high speed spraying flow to drive the energy-converting unit 20 to thereby convert kinetic energy into electric energy; while the pressure compensation unit 30 pressurizes the fluid and injects it into the pressure-accumulating unit 10 to continuously supply required fluid and maintain a stable working pressure, this is beneficial to use for outputting of a posterior delivery and distributing equipment.

By virtue that during practical operation of the entire electric generating system, the pressure-accumulating cylinder continuously releases the liquid fluid with quite a quantity in a high speed to form a high speed spraying flow by using compressed gas to thereby rotate the turbine of the energy-converting unit, the turbine thereby creates a better rotating effect. And before normal electric generating of the entire electric generating system, the pre-stored electric power of the electric cell is used (or by way of direct pressurizing of a high-pressure gas bottle) to make the pressure-accumulating unit get a working pressure sufficient for driving the energy-converting unit to run; and after power generating of the electric generating system, a part of the electric power is switched to afford running a pressurizing pump of the pressure compensation unit, the fluid recovered by the pressurizing pump is pressurized and injected into the pressure-accumulating cylinder of the pressure-accumulating unit; and during supplying fluid in the recycling mode, the pressure-accumulating cylinder will compress the internal gas to reduce its volume by injection of the fluid, thus the pressure-accumulating cylinder can get an effect of pressure compensation; so that after normal electric generating of the electric generating system, supplying of electric power of the electric cell is stopped.

Especially, when in electric generating of the entire electric generating system, the pre-stored electric power is converted into compressive kinetic energy for rotating the turbine; or a kind of pre-stored compressive kinetic energy (from the high-pressure gas bottle) is formed for rotating the turbine, then the turbine actuates the electric generator to further convert the kinetic energy into electric power, and a part of the electric power is converted into compressive kinetic energy to maintain running of the entire electric generating system; after suitable amount of energy consumption, an object of sustaining electric generating by the mode of converting of energy can be realized. This not only can use the electric power generated as auxiliary electric power, but also no problem of public pollution will be induced during the process of operation of the electric generating system by the fact that there is no burning of any energy source. Further, two or more than two set of pressure compensation units can be used in the same electric generating system, the pressurizing pumps of the pressure compensation units can thereby alternately run to prolong the continuous operating durability of the same electric generating system. Surely, electric generating can be implemented by alternate running of the two or more than two set of pressure compensation units, so that in an operation requiring long-time electric power supplying, the rate of superiority of the electric generating system can be assured.

And even, the present electric generating system can be combined with a water storage/supplying system of a multi-storied building, so that the water head of the multi-storied building can be used to convert the energy of the water level to run an air compressor, alternatively, the stored water with a high water level (i.e., the liquid fluid for the pressure-accumulating unit for rotating the turbine) is injected into the pressure-accumulating cylinder with a low water level to get an object of storing the energy in the pressure-accumulating unit.

As is the description disclosed above, the present invention provides a system to sustain electric generating by effectively converting energy.

While the description and the drawings given are only for illustrating the embodiment of the present invention, and not for giving any limitation to the scope of the present invention; it will be apparent to those skilled in this art that various equivalent modifications or changes without departing from the spirit of this invention shall also fall within the scope of the appended claims. Having thus described the present invention, what I claim as new and desire to be secured by Letters Patent of the United States are:

1. A system for electric generating using accumulation pressure, said electric generating system comprises:
a pressure-accumulating unit to store fluid with adequate pressure and amount, said fluid is released continuously with a high speed in operation;
an energy-converting unit running under a high speed fluid spraying action released from said pressure-accumulating unit to thereby convert kinetic energy into electric energy; and
a pressure compensation unit pressurizing said fluid and injecting it into said pressure-accumulating unit to supply required fluid continuously and maintain a stable working pressure, this is beneficial to use for outputting of a delivery and distributing equipment.

2. The system for electric generating using accumulation pressure as in claim 1, wherein: said pressure-accumulating unit is provided with a pressure-accumulating cylinder; said pressure-accumulating cylinder is provided with a fluid spraying pipe in order that said fluid is released with said high speed, and is provided with a fluid injection hole for inputting said fluid.

3. The system for electric generating using accumulation pressure as in claim 1, wherein: said energy-converting unit is provided with a turbine driven by a high speed spraying flow, and provided with an electric generator driven by said turbine.

4. The system for electric generating using accumulation pressure as in claim 1, wherein: said pressure-accumulating unit is provided with a pressurizing pump to inject said fluid into said pressure-accumulating cylinder.

5. The system for electric generating using accumulation pressure as in claim 4, wherein: said pressurizing pump runs when it receives electric power from said electric generating system.

6. The system for electric generating using accumulation pressure as in claim 4, wherein: said pressurizing pump is driven by an electric cell; after power generating of said electric generating system, a part of said electric power is switched to afford running said pressurizing pump.

7. The system for electric generating using accumulation pressure as in claim 1, wherein: said pressure-accumulating unit is provided with a pressure-accumulating cylinder; said pressure-accumulating cylinder is provided with a fluid spraying pipe in order that said fluid is released with a high speed, and is provided with a fluid injection hole for inputting said fluid; said pressure-accumulating unit is provided with a pressurizing pump, said pressurizing pump is provided with a water injecting pipe connecting to a fluid injection hole of said pressure-accumulating cylinder, said pressurizing pump pressurizes said fluid and injects it into said pressure-accumulating cylinder of said pressure-accumulating unit.

8. The system for electric generating using accumulation pressure as in claim 1, wherein: said fluid stored in said pressure-accumulating unit is liquid fluid, and compressed gas is generated to continuously release said liquid fluid in a high speed.

9. The system for electric generating using accumulation pressure as in claim 1, wherein: said pressure-accumulating unit is provided with a pressure-accumulating cylinder, said pressure-accumulating cylinder stores liquid fluid and compressed gas, said pressure-accumulating cylinder is provided with a fluid injection hole and a gas injection hole; said pressure-accumulating cylinder further is provided with a fluid spraying pipe extended into a position under a liquid surface of said liquid fluid in said pressure-accumulating cylinder, so that by pressure of said compressed air, said liquid fluid is continuously released from said fluid spraying pipe with a high speed.

10. The system for electric generating using accumulation pressure as in claim 8, wherein: said compressed air is generated by an air compressor; said air compressor is driven by an electric cell; after power generating of said electric generating system, electric power is switched to afford running said air compressor.

11. The system for electric generating using accumulation pressure as in claim 1, wherein: said pressure-accumulating unit is provided with a pressure-accumulating cylinder, said pressure-accumulating cylinder stores liquid fluid and compressed gas, said pressure-accumulating cylinder is provided with a fluid injection hole and a gas injection hole to connect with an air compressor via said gas injection hole; said air compressor is driven by an electric cell, after power generating of said electric generating system, electric power is switched to afford running said air compressor.

12. The system for electric generating using accumulation pressure as in claim 8, wherein: said compressed gas is supplied from a high-pressure gas bottle.

13. The system for electric generating using accumulation pressure as in claim 1, wherein: said pressure-accumulating unit is provided with a pressure-accumulating cylinder, said pressure-accumulating cylinder stores liquid fluid and compressed gas, said pressure-accumulating cylinder is provided with a fluid injection hole and a gas injection hole to connect with an air compressor via said gas injection hole.

14. The system for electric generating using accumulation pressure as in claim 1, wherein: said pressure compensation unit collects discharged fluid from said energy-converting unit, and pressurizes and injects said collected fluid into said pressure-accumulating unit.

15. The system for electric generating using accumulation pressure as in claim 1, wherein: said pressure compensation unit is provided with a storage tank to collect discharged fluid from said energy-converting unit; and is provided with a pressurizing pump to inject said fluid into said pressure-accumulating cylinder.

16. The system for electric generating using accumulation pressure as in claim 1, wherein: said pressure-accumulating unit is provided with a pressure-accumulating cylinder; said pressure-accumulating cylinder is provided with a fluid spraying pipe in order that said fluid is released with a high speed, and is provided with a fluid injection hole for inputting said fluid; said pressure compensation unit is provided with a storage tank to collect discharged fluid from said energy-converting unit, and said pressure compensation unit is provided with a pressurizing pump; said pressurizing pump is provided with a water-extracting pipe connecting with said storage tank, and is provided with a water injecting pipe connecting to one of said a fluid injection hole of said pressure-accumulating cylinder, said pressurizing pump pressurizes and injects collected fluid into said pressure-accumulating cylinder of said pressure-accumulating unit; said storage tank is injected with fluid of adequate amount to afford fluid extracting of said pressurizing pump.

17. The system for electric generating using accumulation pressure as in claim 1, wherein: said energy-converting unit is provided with a turbine driven by a high speed spraying flow, and with an electric generator driven by said turbine; said turbine and said electric generator are driven by a gear shifting mechanism.

18. The system for electric generating using accumulation pressure as in claim 1, wherein: said energy-converting unit is provided with a turbine driven by a high speed spraying flow, and with an electric generator driven by said turbine; said turbine and said electric generator are driven by a gear shifting mechanism; said gear shifting mechanism has its formed ratio of rotation speed adjusted in pursuance of operating power of said electric generator.

19. The system for electric generating using accumulation pressure as in claim 1, wherein: related components of said pressure-accumulating unit, said energy-converting unit and said pressure compensation unit are arranged on a base.

20. The system for electric generating using accumulation pressure as in claim 1, wherein: related components of said pressure-accumulating unit, said energy-converting unit and said pressure compensation unit are arranged on a base; said energy-converting unit is provided with a turbine driven by a high speed spraying flow, and with an electric generator driven by said turbine; said pressure compensation unit is provided with a storage tank to collect discharged fluid from said energy-converting unit, and said pressure compensation unit is provided with a pressurizing pump; said base is provided with a penetrated area at a position in opposition to said turbine; and said storage tank is allocated under said penetrated area of said base.

21. The system for electric generating using accumulation pressure as in claim 1, wherein: related components of said pressure-accumulating unit, said energy-converting unit and said pressure compensation unit are arranged on a base; said energy-converting unit is provided with a turbine driven by a high speed spraying flow, and with an electric generator driven by said turbine; said base is provided with an obscuring member to impede sputtering fluid from said turbine.

22. The system for electric generating using accumulation pressure as in claim 1, wherein: related components of said pressure-accumulating unit, said energy-converting unit and said pressure compensation unit are arranged on a base; said energy-converting unit is provided with a turbine driven by a high speed spraying flow, and with an electric generator driven by said turbine; said base is provided with an obscuring member to impede sputtering fluid from said turbine; said base is provided with a penetrated area at a position in opposition to said turbine, said obscuring member is allocated in contiguity to said penetrated area, and said storage tank is allocated under said penetrated area of said base.

23. The system for electric generating using accumulation pressure as in claim 1, wherein: related components of said pressure-accumulating unit, said energy-converting unit and said pressure compensation unit are arranged on a base; said energy-converting unit is provided with a turbine driven by a high speed spraying flow, and with an electric generator driven by said turbine; said base is provided with an obscuring member to impede sputtering fluid from said turbine; a stop plate is provided at a partial section between said obscuring member and said turbine.

24. The system for electric generating using accumulation pressure as in claim 1, wherein: said pressure-accumulating unit continuously releases said fluid with a high speed by pressure of compressed air, said compressed air is obtained by running an air compressor by a function of energy of a water head.

25. The system for electric generating using accumulation pressure as in claim 1, wherein: said fluid stored in said pressure-accumulating unit is liquid fluid which is used to transmit a function of pressure of a water head into said pressure-accumulating unit.

26. The system for electric generating using accumulation pressure as in claim 1, wherein: said fluid stored in said pressure-accumulating unit is liquid fluid, said pressure compensation unit injects said liquid fluid into said pressure-accumulating unit by a function of pressure of a water head.

27. The system for electric generating using accumulation pressure as in claim 1, wherein: said fluid stored in said pressure-accumulating unit is liquid fluid which is used to transmit a function of pressure of a water head into said pressure-accumulating unit; said pressure-accumulating unit continuously releases said fluid with a high speed by pressure of compressed air, said compressed air is obtained by running an air compressor by a function of energy of a water head; said pressure compensation unit injects said fluid into said pressure—accumulating unit by a function of pressure of a water head.
